(19) United States
(12) Patent Application Publication
(10) Pub. No.: US 2004/0231400 A1
(43) Pub. Date: Nov. 25, 2004

(54) Method and apparatus for detecting accumulation of particulate matter from a flowing air stream

(76) Inventor: Kenneth A. Bradenbaugh, Concord, OH (US)

Correspondence Address: DOUGLAS H. MAY, P.O. Box 14427, HUMBLE, TX, 77347, US

(21) Appl. No.: 10/440,792

(22) Filed: May 19, 2003

(51) Int. Cl. G01N 37/00

(52) U.S. Cl. 73/28.01

(57) ABSTRACT

Methods and apparatus are disclosed for measuring, collecting and responding to the measured amounts of particulate matter in a flowing air stream. Air stream filtering collects particulate matter on the filter media. At some point the collected particulate matter can clog the filter to the point where it can reduce the air flow to less than desirable levels or even block air flow to cause over heating or other dangerous conditions to occur. A fully automated and self checking electronic system is provided to monitor and control apparatus and to cause alarm or shutoff signals to be generated.

### TECHNICAL FIELD

The present invention relates to methods and apparatus for detecting the accumulation of particulate matter accumulated from a flowing air stream. In particular, the present invention relates to methods and apparatus for accumulating particulates from a flowing air stream, sensing the amount of particulates accumulated and providing a signal upon accumulation of an amount of particulates which may have a deleterious effect upon the flow of the air stream.

### BACKGROUND OF THE INVENTION

Many items of equipment, including commercial and home appliances, utilize air, from a flowing air stream, in their operation. For example, flowing air streams are employed to provide air for such purposes as cooling, ventilating or as combustion air for such equipment. Examples of equipment which utilize such air streams include air conditioners, water heaters, furnaces, cooking equipment, boilers and the like.

Interruption or substantial reduction in the flow of air to such equipment may result in reduced performance or damage to the equipment. In certain cases, such as the flow of cooling air to equipment, a reduction in air flow may result in dangerous overheating and possibly fire.

One common cause for the reduction in flow of air to equipment is a blockage of the air flow path by accumulation of particulate matter from the flowing air. Most sources of air, for use in equipment, contains particulates, such as lint, animal hair and dander ,dust, pollen and other suspended or entrained particulates. Accumulation of such particulates on the surface of filters in the air streams, on the surface of conduits within which the air streams flow ,or within the equipment itself, may, if allowed to accumulate to a sufficient extent, reduce or block the flow of air to the equipment.

Various means are employed for detecting an unacceptable or hazardous accumulations of particulates in an air stream supplying equipment. Such means include visual inspection of filters and air conduit walls, and sensing temperatures of equipment to which air streams are supplied. One common device for sensing and reacting to flow reduction or blockage of an air stream is a mechanical Thermal Cut Off, (“TCO”), device. In use, a TCO is installed in an air stream supplying air to equipment. The TCO senses a selected operating temperature and, upon detecting a temperature outside an acceptable operating range, interrupts operation of the equipment until the cause of blockage or flow restriction is remedied or removed. Visual inspection of the air filters and conduits depends upon the diligence of the inspectors. Mechanical devices, such as TCO devices, are subject to broad operating tolerances due to such conditions as subtle changes in the operating environment over long periods of time, humid conditions, installation location and contaminants, (such as the particulates), in the air.

### SUMMARY OF THE INVENTION

Now, according to the present invention, I have invented improved methods and apparatus for detecting the accumulation of particulates in flowing air streams which accumulated particulates may restrict or block the flow of the air. Further, according to the present invention, upon detecting an amount of accumulated particulates which may cause restriction or blockage of the air stream, a signal is produced which causes the appliance which the air stream supplies to cease operation and/or to provide a visual or audible display to alert personnel that the air stream needs servicing.

Apparatus of the present invention comprises:

a particle accumulator located in the flowing air stream for collecting and accumulating entrained particulates from at least a portion of the air stream;

a radiation source, for directing radiation through the accumulated particulates collected on the particle accumulator;

a radiation detector for measuring the amount of radiation transmitted from the radiation source through the accumulated particulates collected on the particle accumulator; and

signal means for providing a signal upon the radiation detector detecting a low level of transmitted radiation, indicative of an accumulation of particulates which might cause restriction or blockage of air flow in the air stream.

The method of the present invention comprises:

placing a particle accumulator in an air stream in a position for collecting at least a major portion of entrained particulates from the air stream and accumulating the collected particulates over time in a position for measuring the amount of accumulated particulates from time to time;

placing a radiation source in a position to direct emitted radiation through the accumulation of collected particulates;

placing a radiation detector in a position to receive and measure radiation transmitted from the radiation source through the accumulated particulates;

selecting a low level of radiation which is indicative of an accumulation of particulates which might cause restriction or blockage of the air stream;

upon the radiation sensor detecting the selected low level of radiation, activating a signal device to provide a signal indicating that the accumulation of particulates has reached an amount which might cause restriction or blockage of the air stream.

### BRIEF DESCRIPTION OF THE DRAWINGS

FIGS. 1a and 1b are schematic views of, respectively, a face view and a sectional view of a first embodiment of the apparatus of the present invention.

FIG. 2 is a schematic view showing apparatus of the present invention installed in a filter which removes particulates from a flowing air stream.

FIGS. 3a and 3b are, respectively, a schematic face view and a schematic sectional view illustrating .a second embodiment of apparatus of the present invention.

FIGS. 4a and 4b are, respectively, a schematic face view and a schematic sectional view illustrating a third embodiment of apparatus of the present invention.

FIG. 5 is a circuit diagram showing an embodiment of electrical circuitry of the present invention.

FIG. 6 is a circuit diagram showing a second embodiment of electrical circuitry of the present invention.

FIG. 7 is a schematic view showing a capillary heat transfer assembly apparatus of the present invention

### DETAILED DESCRIPTION OF THE INVENTION

The detailed description of the invention which follows is made with reference to the drawings and in terms of preferred embodiments of the invention. The detailed description is not intended to limit the scope of the present invention, and the only limitations intended are those embodied in the claims appended hereto, when taken in conjunction with these drawings and descriptions.

The apparatus of the present invention monitors the accumulation of particulates collected on a particle accumulator located in an air stream. The collected particulates are accumulated on the particle accumulator over time. The accumulation of particulates is monitored, either continuously or from time to time, to determine the amount of such accumulated particulates. The amount of accumulated particulates is determined by measuring, with a radiation detector, the level, amount, or intensity of radiation transmitted from a radiation source through the accumulated particulates to the radiation detector. The amount of accumulated particulates is inversely proportional to the level of radiation transmitted through the accumulated particulates. That is, as the accumulation of particulates builds up, the level of radiation transmitted through the accumulated particulates decreases. At a preselected low level of radiation detected by the radiation detector, indicative of an accumulation of particulates which may deleteriously retard or block the flow of the air stream, a signal is generated. The signal activates shut down of the equipment which the air stream supplies and/or activates a visual and or audible alarm to protect the equipment from damage from a retarded or blocked air supply.

The particulate accumulator is a device for collecting and accumulating entrained particulates from a flowing air stream and displaying the accumulated particulates in a manner such that radiation from a radiation source may be directed through the accumulated particulates. In operation, the particulate accumulator is located in a flowing air stream in a position such that at least a portion of the air stream has substantially unimpeded access to the particle accumulator. As the air stream flows through the particulate accumulator, particulates entrained therein are collected on the particulate accumulator. The particulate accumulator collects and accumulates at least a major fraction of entrained particulates from the air stream sufficient to indicate an accumulation of particulates which may retard or block flow of air to a degree sufficient to have a deleterious effect upon equipment relying upon air from the air stream. The particulates collected in the particulate accumulator are accumulated over time to indicate the accumulation of particulates in the equipment which can be expected over the same period of time. The accumulation of particulates accumulated are measured by detecting the portion of radiation from the radiation source which reaches the radiation detector. A decrease in the fraction of radiation detected indicates an increase in the amount of particulates accumulated.

The particulate accumulator has the following properties: in a clean condition, (no accumulated particulates): the particulate accumulator will allow flow of the portion of the air stream passing therethrough at a rate at least approximating the rate of flow of the portion of the air stream which does not pass through the particulate accumulator; the particulate accumulator will pass at least a major portion of radiation from the radiation source to the radiation detector; and , the particulate accumulator means will collect and accumulate a substantial portion of the entrained particulates from the air stream passing through the particulate accumulator, at least representative of the accumulation of particulates which can be expected in the equipment which the air stream serves. Non limiting examples of materials which may comprise the particulate accumulator include screens, fiber filters and members having surfaces to which entrained particulates are attracted, as by electrostatic attraction. Preferably, the particulate accumulator comprise a screen having a mesh size sufficient to collect a substantial portion of entrained particulates from the portion of the air stream passing through the particulate accumulator and having a fabric which allows transmission of a substantial portion of the radiation striking the particulate accumulator from the radiation source. Most preferably, the particulate accumulator comprises a screen having a fabric of a thermoplastic material which will allow transmission of infrared radiation.

Radiation sources useful in the present invention are those which generates radiation which can penetrate the particulate accumulator in a clean condition and which will be attenuated by the accumulation of particulates on the particulate accumulator. Examples of radiation which may be employed in the present invention include radioactive radiation, radio waves and light waves. A preferable radiation source is one which produces infrared radiation. A light emitting diode which generates infrared radiation is a particularly preferred radiation source. Infrared radiation may be directed from the radiation source through the particulate accumulator to the radiation detector; is attenuated in proportion to the accumulation of particulates; and is not substantially interfered with by incident light which may be encountered. Additionally, infrared radiation sources, such as light emitting diodes, are relatively inexpensive and are defendable in operation. Infrared light emitting diodes require only low power sources and may be powered by rectified AC current or by such means as thermocouples or thermistors which may be driven by heat which is generated by the equipment, such as by pilot flames. Also, infrared diodes may be powered by photoelectric cells which are driven by available incident light or by light from sources such as pilot flames or combustion flames of the equipment involved.

Radiation detectors useful in the present invention are those which will detect radiation transmitted from the radiation source through the particulate accumulator and which produce an output proportional to the radiation received. Preferably, when the radiation source is a source of infrared radiation, radiation detectors are photovoltaic cells sensitive to the infrared radiation.

Signal means employed in the present invention receive an output from the radiation detector indicating that the accumulation of particulates in the particle accumulator is of such an amount that the flow of the air stream may be retarded or blocked to an unacceptable extent. Upon receipt of such an output from the radiation detector, the signal means sends an alarm signal(s) to notify personnel that such unacceptable accumulation may have occurred. The signal means may also send a signal to shut down the equipment served by the air stream. Preferably, the signal means is an electronic circuit which measures the radiation detector output and, upon detection of a radiation detector output indicative of possible retardation or blockage of the air stream flow, produces one or more such signals. The signals produced by the signal means may include a signal to shut down the equipment served by the air stream and/or a visual or audible signal. Signals from the signal means are produced upon the signal means determining that the out put from the radiation detector is at or below a selected value, such selected value being indicative of an unacceptable accumulation of particulates in the particulate accumulator. For example, the selected output value may be a set predetermined value below the radiation detector output when the particulate accumulator is clean. Alternatively, the selected output value may be an output value which is experimentally found based upon experience with the radiation source, particulate accumulator and radiation detector employed, and which is indicative of an unacceptable accumulation of particulates.

Preferred embodiments of the present invention will now be described with reference to the drawings.

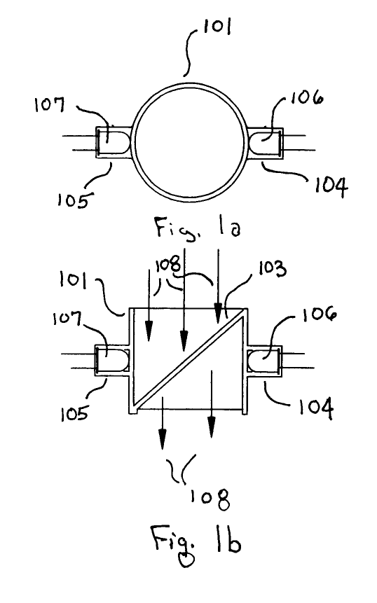

FIG. 1a is a face on view, and FIG. 1b a sectional view showing schematically apparatus of one embodiment of the present invention for collecting and accumulating particulates from a flowing air stream and for detecting the accumulation of such particulates. In FIGS. 1a and 1b, particulate accumulator 103 is mounted at an acute angle across the diameter of cylindrical housing 101. Radiation source housing 104 and radiation detector housing 105,are both connected to cylindrical housing 101 for holding, respectively, radiation source 106 and radiation detector 107 such that radiation from radiation source 106 will be transmitted through particulate accumulator 103 to radiation detector 107. As described above, particulate accumulator 103, in a clean condition, will preferably pass at least a major portion of radiation from radiation source 106 to radiation detector 107.

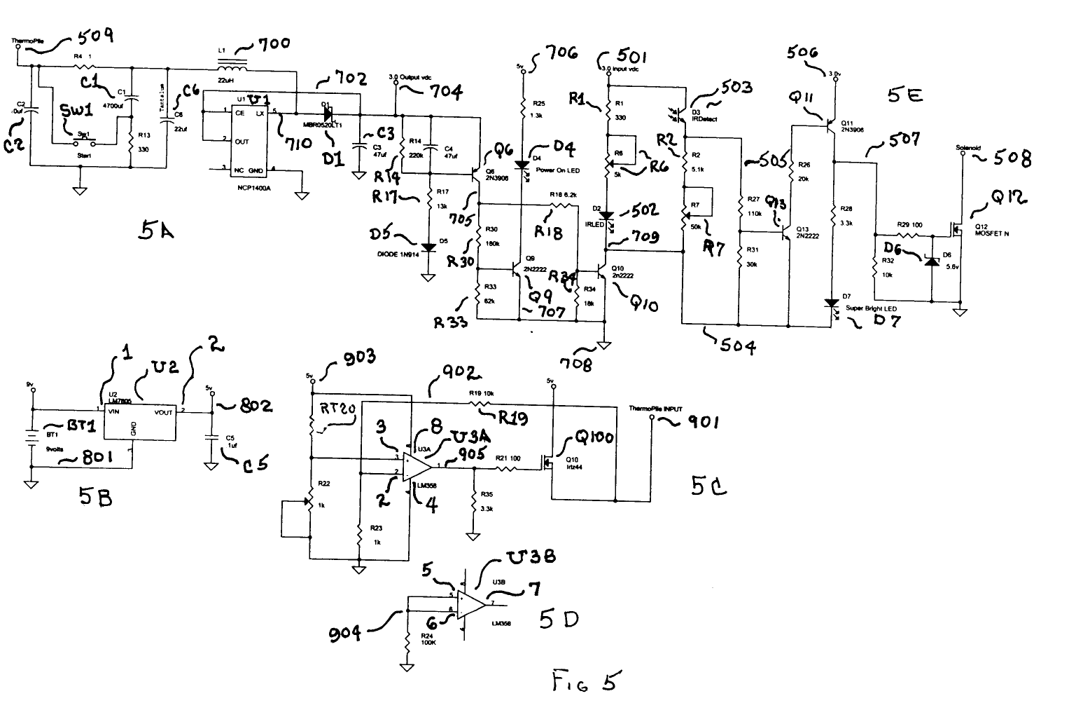

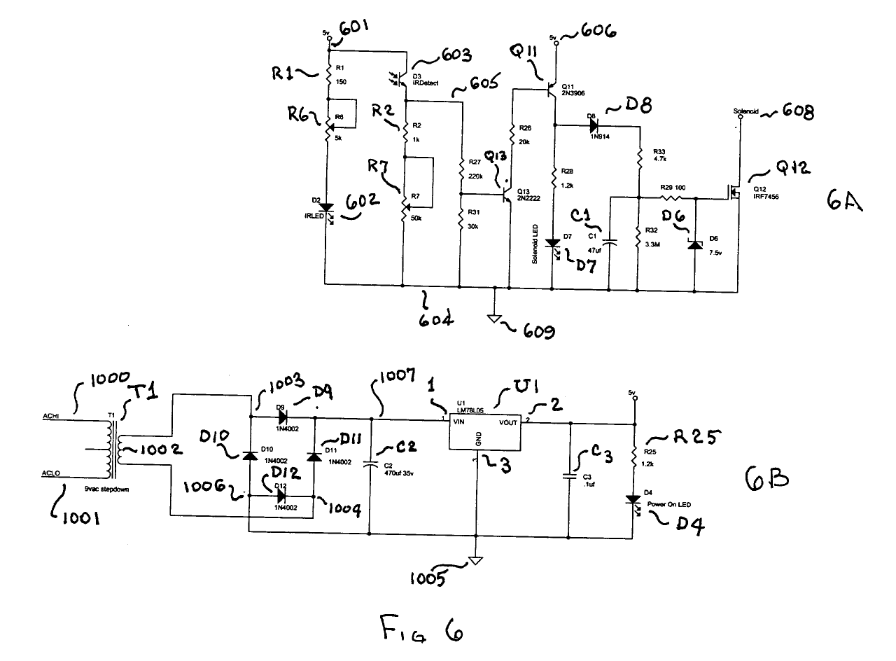

In FIG. 1a and FIG. 1b, air flowing through cylindrical housing 101 is indicated by arrows 108. Particulates from air stream 108 are collected by and accumulate on particulate accumulator 103. Radiation emitted from radiation source 106 is directed toward radiation receiver 107 through particulate accumulator 103 and particulates accumulated thereon. A portion of the emitted radiation is absorbed by particulates accumulated on particulate accumulator 103 and a portion is transmitted to radiation detector 107. that is radiation emitted from radiation source 106 is attenuated in intensity, due to absorption of a portion of the radiation by particulate accumulator 103 and the particulates accumulated thereon. As described below with reference to FIGS. 5 and 6, radiation detector 107 produces an electrical output proportional to the intensity of radiation received. Upon the intensity of radiation at radiation detector 107 falling to a selected low value, commensurate with an undesired accumulation of particulates on particulate accumulator 103, the output of radiation detector 107 activates signal means,(not shown) to give notice of the undesired particulate accumulation and/or to shut down the equipment supplied by air stream 108.

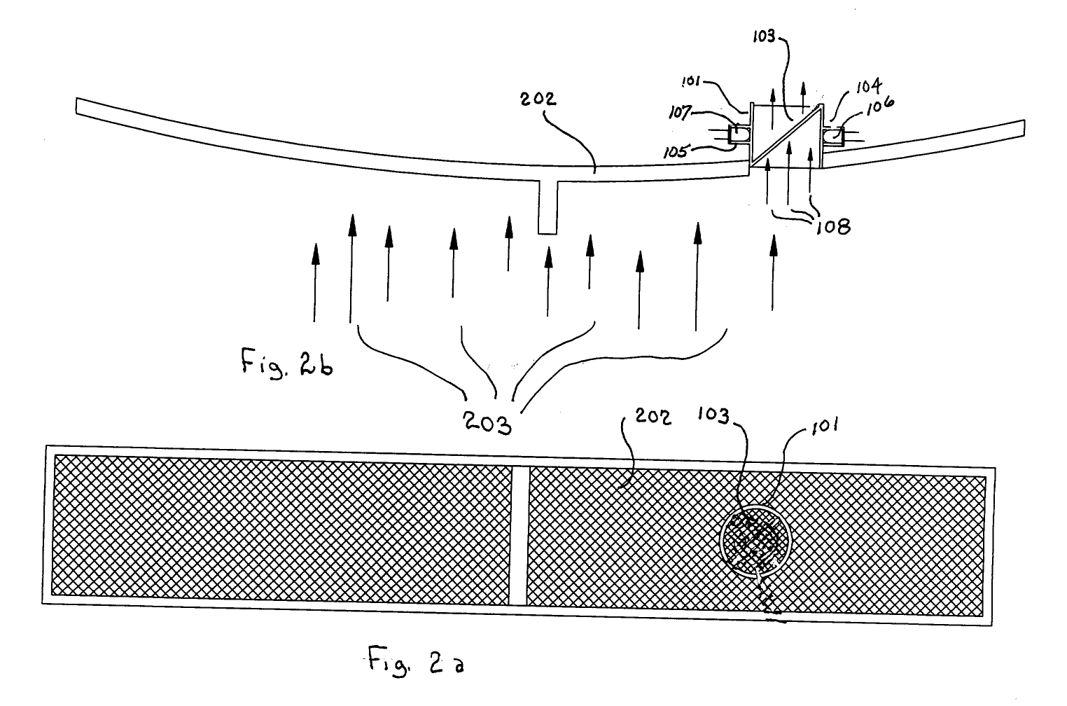

FIG. 2a is a face view and FIG. 2b is a sectional view of the apparatus of FIG. 1a and FIG. 1b installed in a filter 202 for removing particulates from a flowing air stream 203. In FIG. 2a and FIG. 2b, cylindrical housing 101 is mounted in filter 202 and particulate accumulator 103 faces upstream in flowing air stream flow. In this arrangement, the air stream portion 108 of the full flowing air stream 203 through particulate accumulator 103. Filter materials comprising particulate accumulator 103 and filter 202 are preferably selected such that, in a clean condition, resistance to air flow and efficiency for collecting and accumulating particulates are substantially the same for both particulate accumulator 103 and filter 202. By utilizing such similar filter materials, the rate of accumulation of particulates on particle accumulator 103 and filter 202 will be substantially the same and detection of an undesirable accumulation of particulates on particulate accumulator 103 is indicative of an undesirable accumulation of particulates on filter 202.

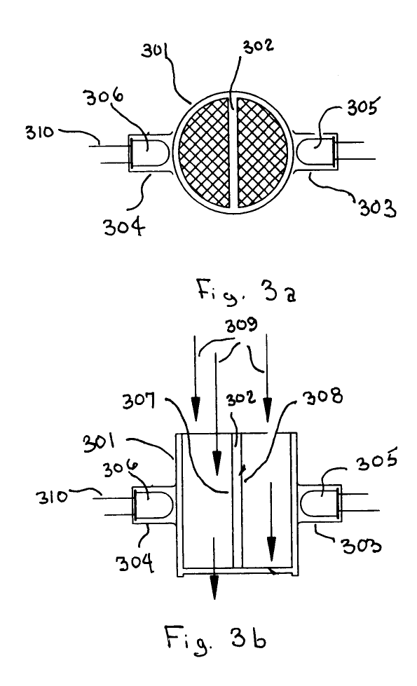

FIG. 3a is a schematic face view and FIG. 3b is a schematic sectional view of a second embodiment of apparatus for detecting accumulation of particulates from a flowing air stream, according to the present invention. In FIG. 3a and FIG. 3b, particulate accumulator 302, having surfaces 307 and 308 is longitudinally aligned with the axis of cylindrical housing 301. Radiation source housing 303 and radiation detector housing 304 are connected to cylindrical housing 301 in an orientation such that radiation from radiation source 305 will be directed transversely through particulate accumulator 302 to radiation detector 306. Particulate accumulator 302, in a clean condition, is substantially transparent to radiation emitted by radiation source 306. In FIG. 3b, an air stream, designated by arrows 309, flows into cylindrical housing 301, along particulate accumulator surfaces 307 and 308. The texture of surfaces 307 and 308 are selected such that particulates from air stream 309 will collect and accumulate thereon. Static electrical charges, generated by air stream 309 flowing over surfaces 307 and 308, may aid in collection and accumulation of particulates. A wide variety of materials, substantially transparent to the radiation employed and textured to collect and accumulate particulates from air stream 309 are suitable for particulate accumulator 302. For example, screens having a mesh and fabrics having a nap suitable for collecting and accumulating particulates. In cases where radiation emitted by radiation source 305 is infrared radiation, particulate collector 302 is preferably made from an electrically insulating material. Electrically insulating materials have improved transparency to infrared radiation compared to electrically conductive materials. Many electrically insulating materials, such as thermoplastic resins and cloth fabrics, which are substantially opaque to visible light are substantially transparent to infrared radiation and may be used in the present invention.

In FIGS. 3a and 3b, particulates accumulate on both surfaces 307 and 308. Radiation emitted from radiation source 305 is attenuated upon transmission through the particulates accumulated on particulate collector 302, such that radiation received at radiation detector 306 is at a lower intensity than the radiation emitted by radiation source 305. As accumulation of particulates on surfaces 307 and 308 increases, attenuation of the emitted radiation increases and radiation intensity detected at radiation detector will decrease. As described below, with reference to FIGS. 5 and 6, radiation detector 306 produces an electrical output proportional to the intensity of radiation received. Upon the intensity of radiation received by radiation detector 306 falling to a selected low level, commensurate with an undesirable accumulation of particulates on surfaces 307 and 308, the electrical output of radiation detector 306, via line 310, activates signal means to give notice of the undesired particulate accumulation and/or to shut down equipment dependent upon the flowing air stream 309.

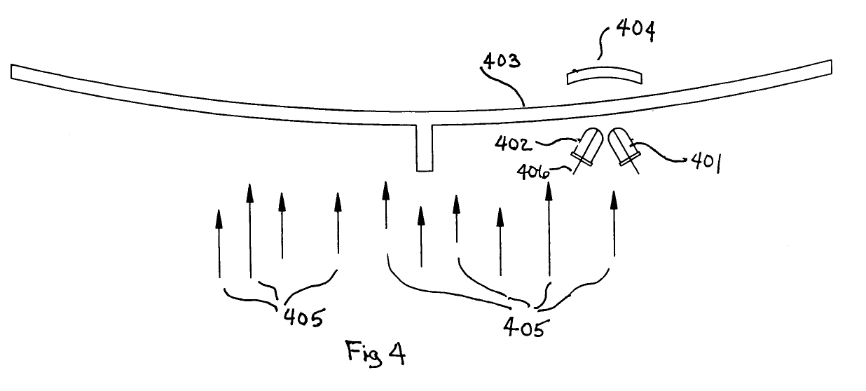

In FIG. 4, a schematic sectional view of a third embodiment of the apparatus of the present invention is shown. In FIG. 4, an air filter 403 is located in a flowing air stream 405. a radiation source 401 and a radiation detector 402 are both located upstream of filter 403 and a radiation reflector 404 is located downstream from filter 403. Radiation from radiation source 401 is directed through filter 403 and strikes radiation reflector 404. From radiation reflector 404, the radiation is reflected back through particulate accumulator 403 to radiation detector 402. Filter 403 collects and accumulates particulates from an air stream 405. Radiation emitted from radiation source 401 is attenuated by its transmission, reflection and retransmission through filter 403 and particulates accumulated thereon, such that the intensity of radiation received at radiation detector 402 is less than the intensity of radiation emitted by radiation source 401. As is described under FIG. 6 and 6 below, upon the intensity received at radiation detector 402 being reduced to a selected low intensity, indicative of an undesirable accumulation of particulates on filter 403, a signal is generated giving notice of the undesirable accumulation of particulates indicating an alarm condition and/or shutting down equipment dependent upon air stream 405.

In a preferred embodiment, filter 403 is a filter or screen which collects and accumulates particulates from the entire air stream 405 and particulate accumulation is monitored by the apparatus of FIG. 4 in only a small area thereof. This preferred embodiment has two advantages. First, accumulation of particulates monitored by the apparatus of FIG. 4 will be substantially the same as the accumulation of particulates across the length of filter 403 located in the path of the entire air stream 405, such that detection of the accumulation of particulates by the apparatus of FIG. 4 will be representative of the accumulation of particulates across the length of filter 403. Second, radiation source 401 and radiation detector 402 may both be located upstream of filter 403 for easy access and servicing.

In FIG. 4, with filter 403 in a clean condition, radiation reflector 404 will preferably reflect at least a substantial portion of the radiation transmitted from radiation source 401 through filter 403 and back through filter 403 to radiation detector 402. Preferably, radiation source 401 is a source of infrared radiation, radiation reflector 404 is a parabolic mirror and filter 403 comprises filter material substantially transparent to infrared radiation. As described below, with reference to FIGS. 5 and 6, radiation detector 402 produces an electrical output proportional to the intensity received. Upon the intensity of radiation received by radiation detector 402 decreasing to a selected low level, commensurate with an undesirable accumulation of particulates on filter 403, the electrical output of radiation detector 402, via line 406, activates signal means to give notice of the undesired particulate accumulation and/or to shut down equipment dependent upon the flowing air stream 405

Referring now to FIGS. 5 and 6, preferred embodiments of electronic circuits for detecting accumulation of particulates and signaling upon detection of undesirable accumulations is shown in circuit diagram form. FIGS. 5 and 6 show preferred embodiments for performing the measurement of accumulated particulates and generation of alarm signals functions referred to above.

The overall circuitry of FIG. 5 is divided into subsections labeled 5A, 5B, SC, 5D, and 5E. FIG. 6 is similarly divided into subsections 6A and 6B. For purposes of this description, circuit subsections 5E and 6A may be considered functionally equivalent, but offer alternative arrangements for supplying output or alarm signals.

Referring to drawing subsections 5E and 6A, the circuitry may generally be described as a conditioning trigger (transistor Q13) driving an alarm trigger (MOSFET Q12). A supplied reference voltage (501 in SE and 601 in 6A) establishes an adjustable intensity infrared radiation source (502 in 5E and 602 in 6A).The intensity of infrared radiation sources 502 and 602 may be adjusted, as desired, by adjusting potentiometers R6 and resistors R1 to a desired base level of intensity or luminosity. The input voltage at 501 and 601 also provides operating voltage for infrared radiation detector transistor (503 in 5E and 603 in 6A) which is placed in proximity to its respective infrared radiation source (502 or 602). The particulate accumulator intervening the infrared radiation source (502 and 602)and infrared radiation detector (503 and 603) is exposed to an air stream containing particulates. Particulate accumulation on the particulate accumulator attenuates the luminosity or intensity of infrared radiation from the radiation source (502 and 602) as detected by its associated infrared radiation detector (503 and 603). The detection level (or sensitivity) of the infrared radiation detector is adjusted by resistor R2 and potentiometer R7 in slightly different manners in 5E and 6A. In 5E, line 504 is floating above ground by an amount of voltage controlled by the current through {or conductivity of} transistor Q10 of subsection 5A. In 6A, for line 604 the voltage is fixed at ground potential via ground contact 609. Transistor Q1 may then be referred to as a preconditioning set point controller, if desired.

Output signals from infrared radiation detectors 503 and 603 are supplied, respectively via lines 505 and 605, to the base of transistor Q13(a 2N2222) which is supplied with operating voltage at 506 and 606,from a voltage source via the conductivity of transistor Q11. In SE, when Q11 starts to conduct, the superbright LED (D7 of SE) is turned on as a visual signal. Similarly, current through Q11 causes a voltage drop on line 507. This voltage drop, in turn, causes a voltage change (or signal change) at the control gate of MOSFET Q12. Prior to initiation of conduction of Q11, the control gate of Q11 is held at a fixed reference voltage of 5.6 volts by zener diode D6 (which reference voltage could, of course, vary as desired with type of equipment, signal levels, etc.). The signal change at the control gate of MOSFET Q12 activates a solenoid 508 which provides an electromechanical output signal as desired to accompany the visual output from superbright LED D7.

In subsection 6A, an output signal from transistor Q11 is forced negative by the rectifying action of diode D8(1N914). This causes a charge accumulation on capacitor C1(47 uF). In turn this buildup of charge causes a signal change at the control gate of MOSFET Q12 (IRF2456) which was previously biased to nonconduction via zener diode D6 (a 7.5 volt Zener in this case). This signal change causes MOSFET Q12 to conduct sufficiently to activate solenoid 608 to supply an electro-mechanical output signal to accompany that of LED D7.

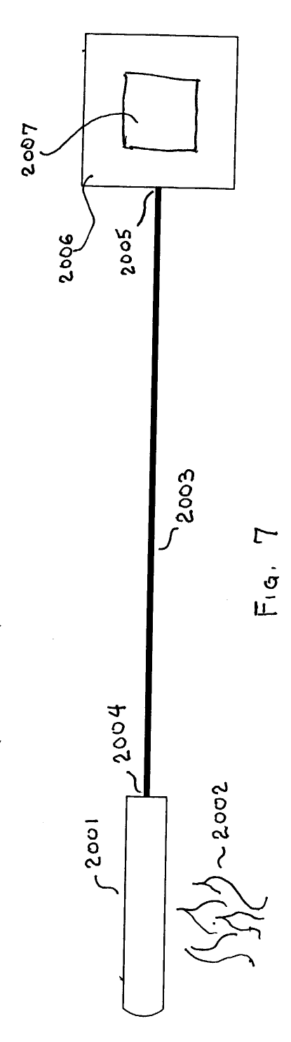

Referring now to FIG. 5 subsection 5A, a circuit capable of operating from a very low voltage (less than one volt) source is shown. In the embodiment shown in 5A, a thermopile 509 (or thermocouple) functions as a thermoelectric generator. Such a thermoelectric generator typically derives a low voltage current by exposing a junction of two dissimilar metals to a heat source such as a flame or a heated portion of a system being monitored and controlled. In 5A, capacitor C1(4700 uF) is charged from the low voltage current supply from thermopile 509 and allowed to build up and store electrical energy in the form of charge until the push button switch SW1 is depressed. Charge is also built up on capacitors C2 (10 uF) and C6 (a 22 uF tantalum capacitor) during the buildup phase. When SW1 is depressed or activated, operating voltage is supplied via choke 700 (having a value of 22 microhenries) and line 710 to control terminal of U1, which is an encapsulated regulated DC power supply circuit of the type NCP1400A. The output voltage of U1 is supplied on line 702 to capacitor C3 (47 uF) and Zener diode D1 (a MBR0520LT1) serves to regulate the output voltage of 3.0 volts at pin 704. It should be mentioned at this point, that while a thermoelectric low voltage source has been disclosed as one embodiment, low voltage photovoltaic cells receiving light from a pilot light or other flame associated with equipment being monitored could be used in an alternative arrangement, if desired. Any suitable or desired low voltage power source supplying current to capacitor C1 is considered to be within the scope of the present invention. One other alternative source of low voltage power is shown in FIG. 7, which will be further discussed below.

When switch SW1 is closed, a voltage signal is supplied to the base and emitter of transistor Q6 (a type 2N3906). Diode D5 (a type 1N914) and associated resistors R14 (220 Kohm) and R17 (13 Kohm) act to cause current flow through transistor Q6, causing an output or signal on line 705. The signal on line 705 is, in turn, supplied to the base of (previously discussed) transistor Q10 via resistor R18 (6.2 Kohm) and also to the base of transistor Q9 (a type 2N2222) via associated resistor network R30 (180 Kohm) and R33 (62 Kohm). When transistor Q9 starts to conduct, a ground return path is provided from the 5 volt source 706 via line 707 to ground 708. The opening of this current path causes the “power on” LED D4 to light, thus providing a visual indication that the circuitry of the particulate accumulation monitor is powered up. Additionally, the voltage signal supplied to the base of transistor Q10 causes the “floating” reference point voltage (at point 709) to reach its desired value (as determined for a specific application by the value of resistors R18(6.21 Kohm) and R34 (18 Kohm).

Referring now to FIG. 5, subsection 5B, a DC to DC power supply providing an out put operating voltage of 5 volts (such as that supplied to point 706 of subsection 5A) is illustrated. Nine volts from a battery BT1 positive terminal (+9.0 volts) is supplied to terminal 1 of encapsulated regulated power circuit U2, comprising a type LM 7805 integrated circuit. Output voltage is supplied from pin 2 of encapsulated regulated power circuit U2 on line 802 and held above ground potential by filter and blocking capacitor C5 (0.1 uF).

Referring now to FIG. 5, subsection 5C, a circuit providing a failsafe feature of the system of the present invention is disclosed. The circuitry of subsection 5C continuously and constantly monitors “normal” temperature activity against its going over to “abnormal” or even dangerous operating temperatures. An input signal from the thermopile (or thermocouple) 509 of subsection 5A is supplied at 901.

The signal output of thermistor RT20 is adjustable by Potentiometer R22. This signal is then compared, via pin 3 of integrated circuit comparator U3A which provides an output on line 905 at its output signal pin 1. The output signal from pin 1 of comparator U3A is supplied to the gate of field effect transistor Q100. When the temperature of thermistor RT20 reaches its high limit, transistor Q100 responds, shutting off the monitored system and or supplying a signal indicating the over temperature condition.

Operating voltage for U3A and U3B are provided on pins 4 and 8 of this single encapsulated dual component integrated circuit (type LM 358). Comparator U3B has both of its inputs (pins 5 and 6 of U3B) connected to a common reference voltage point 904.This produces a no output signal on output pin 7 of U3B unless the entire integrated circuit LM358 malfunctions. This assures the overall system operator of knowing whether the malfunction detector circuit (or safety circuit) is functioning properly. The thermopile input from point 910 is compared against its reference voltage signal and, if found outside the limits or parameters defined by the system, supplies an output signal on line 905. The appearance of such a signal on line 905 changes the conductivity properties of transistor Q100 which thereby affects the circuitry of FIGS. 5 and 6 as discussed in detail previously, to wit: providing visual audible and mechanical alarms and system shutdown.

Referring to FIG. 6, subsection 6B, an alternating current power supply is depicted. Alternating current from a source, such as a commercial power main, or an alternator or the like, is supplied via lines 1000 and 1001 to the input side of a transformer T1 (designated here as a 9 volt AC stepdown transformer). Five volt AC power from the output winding 1002 Of transformer T1 is provided at taps 1003 and 1004 to a full wave bridge rectifier circuit comprising diodes D9, D10, D11 and D12. All of diodes D9-D12 may be matched diodes of type 1N4002, if desired. A filter capacitor C2 (470 micro Farads at 35 VAC working voltage) connected to ground contact 1005 in common with point 1006 in the bridge rectifier circuit removes any excess AC ripple component from the output of the rectifier circuitry. Thus, a smooth positive input voltage is provided, via line 1007, to pin 1 of encapsulated regulated output supply circuit U1 (an LM7805 integrated circuit). Pin 3 of U1 is grounded to ground contact 1005, as is one side of filter capacitor C3 (1uF), and the cathode side of “power on” light emitting diode D4. Thus, output pin 2 of encapsulated regulated integrated circuit U1, shown in FIG. 6, subsection 6B, generates regulated 5 volt positive DC output voltage. This voltage is used to power the circuits of FIGS. 5 and 6 with 5 volt operating power, and to operate light emitting diode D4 via current limiting resistor R25 (1.2 K ohm) to give a visual “power on” signal.

FIG. 7 shows a capillary heat transfer assembly for transferring heat from a high temperature and/or corrosive heat source to a thermoelectric generator, such as a thermopile or thermocouple. The purpose of this assembly is to remove a thermoelectric generator from exposure to a high temperature or corrosive environment and transfer heat from such environment to the thermoelectric generator for use in generating electric power.

In FIG. 7, a flame contact head 2001 is placed in proximity to a flame or other high temperature or corrosive heat source 2002 for absorption of heat therefrom. A first end 2004 of capillary tube 2003 is in heat conductive contact with flame contact head 2001 and a second end 2005 of capillary tube 2003 is in heat conductive contact with a heat transfer plate 2006 Heat transfer plate 2006 is located outside the high temperature or corrosive environment of flame 2002. Capillary tube 2003 is filled with a heat transfer fluid, not shown. In operation, flame contact head 2001 absorbs heat from flame 2002 and transfers such absorbed heat to the heat transfer fluid in capillary tube 2003. Heat transfer fluid transfers such heat to heat transfer plate 2006 at a lower temperature than the flame contact head is exposed to at flame 2002. An electric current is generated by a thermoelectric generator device 2007, such as a thermopile or thermocouple, which is in heat transfer contact with heat transfer plate 2006. Thus, the capillary assembly allows generation of electric power by a thermoelectric generator, utilizing heat from a high temperature source, without exposing the thermoelectric generator to the high temperature or corrosive environment of the high temperature source.

While the present invention has been described with reference to preferred embodiments, the same are to be considered illustrative only and not limiting in character. Many modifications to the methods and apparatus of the present invention will occur to those skilled in the art which modifications do not depart from the spirit and scope of the invention, which is defined only by the claims appended hereto.

I claim and wish to protect by Letters Patent:

1. Apparatus for detecting accumulated particulates collected from a flowing air stream, comprising:
a particulate accumulator located in the flowing air stream for collecting and accumulating particulates from the flowing air stream;
a radiation source located upstream in the flowing air stream from the particulate accumulator for directing radiation through the particulate accumulator;
a radiation detector for detecting the level of radiation transmitted from the radiation source through the particulate accumulator; and
signal means for providing a signal upon the radiation detector sensing a low level of transmitted radiation indicative of a preselected accumulation of particulates on the particulate accumulator.

2. The apparatus of claim 1, wherein the particulate accumulator comprises a screen having a screen mesh of a size sufficient, when the screen is substantially free of accumulated particulates, for the passage of air from the flowing air stream and sufficient for accumulation of particulates from the flowing air stream.

3. The apparatus of claim 1, wherein the radiation detector is located downstream from the particulate detector.

4. The apparatus of claim 1, further comprising:
a radiation reflector located downstream from the particulate accumulator for receiving radiation transmitted from the radiation source through the particulate accumulator and for directing such transmitted radiation to the radiation detector.

5. The apparatus of claim 4, wherein;
the radiation detector is located upstream from the particulate accumulator; and
the radiation reflector directs the transmitted radiation back through the particulate accumulator to the radiation detector.

6. The apparatus of claim 1, wherein the radiation source is an infrared radiation source.

7. The apparatus of claim 6, wherein the radiation source is driven by an energy source selected from the group consisting of:
photovoltaic cell; thermocouple; thermopile; and thermoelectric generator.

8. The apparatus of claim 1, wherein the signal means produces an audible signal.

9. The apparatus of claim 1, wherein the signal means produces a visual signal.

10. The apparatus of claim 1, wherein; the flowing air stream supplies air to an appliance; and the signal means provides a signal for shutting down the appliance.

11. The apparatus of claim 1 and further including an energy source for driving said radiation source, said radiation detector and said signal means which derives its power from a thermoelectric generator.

12. The apparatus of claim 11 wherein said thermoelectric generator is driven by a heat transfer assembly which transfers heat energy from a high temperature portion of the apparatus to a lower temperature portion of the apparatus via a capillary heat transfer assembly.

13. Electronic circuitry useful in detecting accumulated particulates from a flowing air stream collected on a particulate accumulator ,in monitored apparatus, comprising: circuit means for establishing a low level of radiation indicative of a significant amount of accumulated particulate on said particulate accumulator and for providing a comparison base signal corresponding thereto.

14. The circuitry of claim 13 wherein said circuitry is powered by a thermoelectric generator driven by a portion of the operating energy supplied to said monitored apparatus.

15. The circuitry of claim 14 wherein said circuitry indicates readiness of operating power for its own operation by use of a cascaded series of logic comparison gates.

16. The circuitry of claim 15 and further including circuit means for providing a signal representative of real time particulate accumulation in said monitored apparatus and for comparing said real time particulate accumulation signal with said comparison base signal to derive an output signal indicative of safe and/or dangerous operating conditions in said monitored apparatus.

17. The circuitry of claim 16 and further including circuitry for fail safe self checking of its own operation and for providing a fail signal and/or shutdown condition signal if some parameter of the system or some circuitry component fails in operation during monitoring of said monitored apparatus.

18. The circuitry of claim 17 wherein said thermoelectric generator supplies AC power to said circuitry.

19. The circuitry of claim 17 wherein said thermoelectric generator supplies DC power to said circuitry.

20. The circuitry of claim 17 wherein said circuitry further includes power conversion circuitry for converting AC to DC power or DC to AC power.

21. Electronic circuitry useful for detecting accumulated particulates collected from a flowing air stream on a particulate accumulator in monitored apparatus, comprising:
circuit means for establishing a low level of transmitted radiation from said particulate accumulator indicative of a potential critical temperature of said monitored apparatus being reached and for supplying a fail safe signal capable of shutting off the monitored system
